(19) United States
(12) Patent Application Publication
(10) Pub. No.: US 2005/0238118 A1
(43) Pub. Date: Oct. 27, 2005

(54) Method for detecting a signal contaminated by additive gaussian noise and a detector using the method

(76) Inventors: Daniel Asraf, Lulea (SE); Mats Gustafsson, Uppsala (SE)

Correspondence Address: JACOBSON HOLMAN PLLC, 400 SEVENTH STREET N.W., SUITE 600, WASHINGTON, DC, 20004, US

(21) Appl. No.: 10/512,971

(22) PCT Filed: Apr. 29, 2003
(86) PCT No.: PCT/SE03/00680

§ 371 Date: Jun. 6, 2005

(30) Foreign Application Priority Data
Apr. 29, 2002 (SE) 0201280-5

(51) Int. Cl. H04L 27/06

(52) U.S. Cl. 375/316

(57) ABSTRACT

A method for detecting a single or multi dimensional signal contaminated by additive Gaussian noise, and a detector using the method. The signal is an amplitude modulated sinusoid with known, but arbitrary, envelope and carrier frequency, but unknown uniform phase angle. The method comprises the step of calculating the integral for the likelihood ratio

$$L ( X ) = \frac{1}{2 π} {\int }_{- π}^{π} {L}_{ϕ} ( X ) ⅆ ϕ$$

analytically or numerically without limiting assumptions, and to make a comparison with a threshold value for deciding the question of detection.

The present invention relates to a method for detecting a signal contaminated by additive Gaussian noise and a detector using the method.

The noncoherent detection problem is concerned with detecting an amplitude modulated sinusoid, with a known, but arbitrary, envelope and carrier frequency, but A) unknown uniform phase angle, contaminated by additive Gaussian noise. This is a standard problem in optimal detection theory and occurs in many fields of applied signal processing. Common areas of application are telecommunications, radar, sonar and ultrasonic NDE (non-destructive evaluation).

The classical solution to this detection problem is the well known Noncoherent Detector, described i.a. in P. M. Woodward, Probability and Information Theory with Applications to Radar, Oxford, U.K. Pergamon, 1953, and H. V. Poor, An Introduction to Signal Detection and Estimation, New York: Springer-Verlag, 1994, which are incorporated by reference herein.

The noncoherent detector is formulated for scalar signals and is only optimal when the signal envelope is a raised cosine or a function with constant amplitude, possibly with alternating signs. In other cases, i.e. when the envelope does not belong to any of the functions mentioned above, the detector is suboptimal and relies on the assumption that the envelope is slowly varying compared to the carrier frequency, which is called the narrow-band approximation.

The noncoherent detector was developed in the late 1940's as a solution to the noncoherent detection problem and was primarily intended for the radar and communication systems of that time. For these applications it was relevant to detect amplitude modulated sinusoids with relatively long time duration (e.g. a pulse containing 5 or more oscillations of the carrier signal), which implies that the narrow band approximation is very relevant. In the abovementioned book by P. M. Woodward attempts to obtain an analytical solution was made but without success.

In the applications of today, such as high resolution radar and ultrasonic NDE, the narrow band approximation is less suitable since the pulses to detect could be of very short time duration (e.g. a pulse containing 2 or less oscillations of the carrier signal). In these applications the conventional noncoherent detector yields a sub-optimal detection performance (i.e. the probability of detection is not maximized).

In order to improve the probability of detection for the noncoherent detection problem the present invention introduce a new technique which can be realized either by implementing a newly derived analytical solution to the likelihood ratio integral or by solving the integral by means of numerical methods. Furthermore, due to the increasing use of computers to implement detectors in combination with the growing demand for array-sensor systems the conventional scalar formulation has been extended to incorporate detection of signals with arbitrary dimensions. This technique includes a general solution to the noncoherent detection problem in which the restrictions to the particular families of envelopes stated above have been relaxed: The present detector is therefore henceforth referred to as the Generalized Noncoherent Detector. The solution to the present problem follows from the invention being defined as is evident in the following independent claims. The dependent claims define suitable embodiments of the invention.

In the following the invention will be described in more detail with reference to the accompanying drawings, where

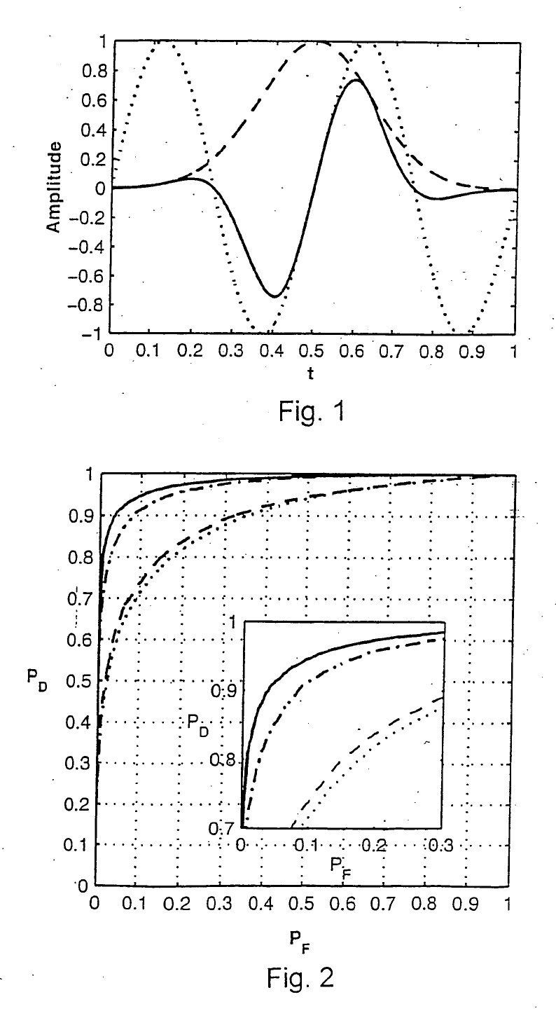

FIG. 1 shows an example of transient signal for φ=0 (solid), envelope signal with t_{c}=0.5, σₑₙᵥ=0.2 (dashed), and carrier signal sin(t×4π×0.001) (dotted).

FIG. 2 shows ROC curves for σₑₙᵥ=0.1 and σᵥ=2 generated with the analytical solution (solid) and the classical noncoherent detector (dash-dotted), and σᵥ=3 with the analytical solution (dashed) and the classical noncoherent detector (dotted). The inserted figure is an amplification of the upper left corner.

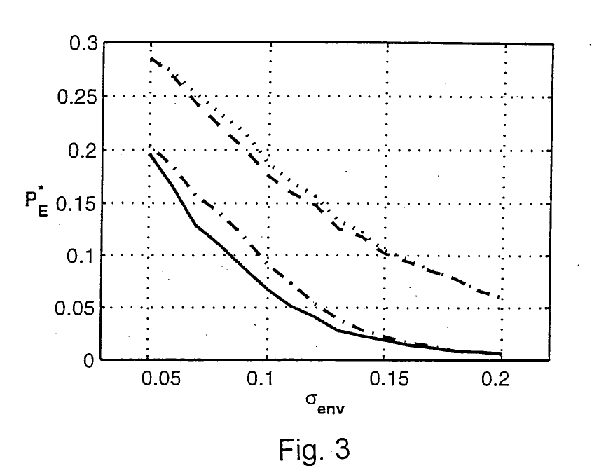

FIG. 3 shows minimum probability of error P_{E}* plotted versus the transient band-width σₑₙᵥ. The curves are generated for the case of σᵥ=2 by using the generalized noncoherent detector (solid) and the conventional noncoherent detector (dash-dotted). The case of σᵥ=3 is also presented for the generalized noncoherent detector (dashed) and the conventional (dotted).

The technique introduced here generalizes the conventional formulation to arbitrary dimensions and offers the advantage of optimal detection performance regardless of the type of signal envelope that is present Hence, the restrictions on the particular families of envelopes imposed by the conventional noncoherent detector are relaxed in this new and more general approach.

The well known noncoherent detection problem is concerned with optimal detection of an amplitude modulated sinusoid with an unknown phase angle in additive Gaussian noise. This may be formulated as the two-hypotheses problem
H₀:X=V
H₁:X=S(φ)+V (1)

Furthermore, V is a N₁×N₂× . . . ×, N_{M}-dimensional tensor which contains samples from an uncorrelated (white) Gaussian stochastic process (noise) with variance σᵥ. Similarily, S(φ) is a N₁×N₂× . . . ×N_{M}-dimensional tensor containing samples of the signal s(x₁, x₂, . . . x_{M})=a(x₁, x₂, . . . , x_{M})sin(ω₁x₁+ω₂x₂+ . . . +ω_{M}x_{M}+φ) to be detected. An element, sₙ_{₁}_{, . . . n}_{_{M}}, of the tensor s(φ) can be described by
Sₙ_{₁}_{, . . . ,n}_{_{M}}(φ)=aₙ_{₁}_{, . . . ,n}_{_{M}} sin((n₁−1)ω₁T₁+ . . . +(n_{M}−1)ω_{M}T_{M}+φ) (2)
where aₙ_{₁}_{, . . . ,n}_{_{M}} is a sample from the known deterministic signal envelope a(x₁, x₂, . . . , x_{M}), ωₘ is the m:th deterministic carrier frequency, Tₘ is the sampling interval for the m:th variable, and φ is a stochastic variable representing the unknown phase angle which is assumed to be uniformly distributed on the unit circle, φ˜∪[−π,π[. Here we consider the white noise case but the results below may be generalized to Gaussian noise processes with completely general autocorrelation functions. A detector, which is optimal in the Neyman-Pearson sense (presented i.a. in the abovementioned book by H. V. Poor), for the hypothesis problem in Eq. (1) can be described by the decision rule

$$δ ( X ) = \{ \begin{matrix}{H}_{0} & if L ( X ) < τ \\ {H}_{1} & if L ( X ) \geq τ\end{matrix} \qquad ( 3 )$$

Here L(·) is the likelihood ratio and τ is a user defined threshold. The computation of the likelihood ratio is the key component in the construction of a detector and mainly determines the detection performance.

The likelihood ratio for the hypothesis problem in Eq. (1) for a fixed φ given an observation X is according to the abovementioned book by H. V. Poor given by

$${L}_{ϕ} ( X ) = exp \{ \frac{1}{{σ}_{v}^{2}} {\sum }_{{n}_{1} = 1}^{{N}_{1}} ⋯ {\sum }_{{n}_{M} = 1}^{{N}_{M}} {s}_{{n}_{1} , … , {n}_{M}} {\times }_{{n}_{1} , … , {n}_{M}} - \frac{1}{2 {σ}_{v}^{2}} {\sum }_{{n}_{1} = 1}^{{N}_{1}} ⋯ {\sum }_{{n}_{M} = 1}^{{N}_{M}} {s}_{{n}_{1} , … , {n}_{M} }^{2} \} . \qquad ( 4 )$$

Also with reference to the book by H. V. Poor this result can be extended to the case with uniformly distributed phase angle φ, thereby yielding the likelihood ratio on the form

$$L ( X ) = \frac{1}{2 π} {\int }_{- π}^{π} {L}_{ϕ} ( X ) ⅆ ϕ \qquad ( 5 )$$

The analytical approach is obtained by inserting, Eq. (4) in Eq. (5) and using general trigonometric relations such as Dₛ cos φ+D_{c} sin φ=r cos(φ−θ) where r=\sqrt{Dₛ²+D_{c}²} and θ=tan⁻¹{D_{c}IDₛ}. The resulting integrand is then represented by a series expansion of Modified Bessel functions. For a general presentation of Modified Bessel functions, please cf. M. Abramowitz and I. Stegun, Handbook of mathematical functions, New York, Dover, 1972, which is incorporated by reference herein. In the present case the Modified Bessel functions are denoted I₆₀ (·), where α={0,1,2, . . . , ∞} is the order. The series expansion is integrated term-wise to yield

$$L ( X ) = {ⅇ}^{- 〈 {a}^{2} 〉 / 4 {σ}_{v}^{2}} [ {I}_{0} ( \frac{{r}_{1}}{{σ}_{v}^{2}} ) {I}_{0} ( \frac{{r}_{2}}{4 {σ}_{v}^{2}} ) + 2 {\sum }_{I = 1}^{∞} {I}_{2 I} ( \frac{{r}_{1}}{{σ}_{v}^{2}} ) {I}_{I} ( \frac{{r}_{2}}{4 {σ}_{v}^{2}} ) cos ( I θ ) ] \qquad ( 6 )$$

where

$$〈 {a}^{2} 〉 = {\sum }_{{n}_{1} = 1}^{{N}_{1}} ⋯ {\sum }_{{n}_{M} = 1}^{{N}_{M}} {a}_{{n}_{1} , … , {n}_{M}}^{2} , \qquad ( 7 )$$

r₁=\sqrt{Aₛ²+A_{c}²},r₂=\sqrt{Bₛ²+B_{c}²}, θ=θ₂−2θ₁, θ₁=tan⁻¹{A_{c}/Aₛ} and θ₂=tan⁻¹{B_{c}/Bₛ}.

The values for Aₛ, A_{c} are computed by

$$\begin{matrix}{A}_{s} = {\sum }_{{n}_{1} = 1}^{{N}_{1}} ⋯ {\sum }_{{n}_{M} = 1}^{{N}_{M}} {a}_{{n}_{1} , … , {n}_{M}} sin ( ( {n}_{1} - 1 ) {ω}_{1} {T}_{1} + ⋯ + ( {n}_{M} - 1 ) {ω}_{M} {T}_{M} ) {x}_{{n}_{1} , … , {n}_{M}} \\ and & ( 8 ) \\ {A}_{c} = {\sum }_{{n}_{1} = 1}^{{N}_{1}} ⋯ {\sum }_{{n}_{M} = 1}^{{N}_{M}} {a}_{{n}_{1} , … , {n}_{M}} cos ( ( {n}_{1} - 1 ) {ω}_{1} {T}_{1} + ⋯ + ( {n}_{M} - 1 ) {ω}_{M} {T}_{M} ) {x}_{{n}_{1} , … , {n}_{M}} . & ( 9 )\end{matrix}$$

The values for Bₛ, B_{c} are given by

$$\begin{matrix}{B}_{s} = {\sum }_{{n}_{1} = 1}^{{N}_{1}} ⋯ {\sum }_{{n}_{M} = 1}^{{N}_{M}} {a}_{{n}_{1} , … , {n}_{M}}^{2} sin ( ( {n}_{1} - 1 ) {ω}_{1} {T}_{1} + ⋯ + ( {n}_{M} - 1 ) {ω}_{M} {T}_{M} ) \\ and & ( 10 ) \\ {B}_{c} = {\sum }_{{n}_{1} = 1}^{{N}_{1}} ⋯ {\sum }_{{n}_{M} = 1}^{{N}_{M}} {a}_{{n}_{1} , … , {n}_{M}}^{2} cos ( ( {n}_{1} - 1 ) {ω}_{1} {T}_{1} + ⋯ + ( {n}_{M} - 1 ) {ω}_{M} {T}_{M} ) . & ( 11 )\end{matrix}$$

The expression in Eq. (6) is an analytical solution to the likelihood ratio for the noncoherent detection problem stated in Eq. (1). In order to implement Eq. (6) (e.g. on a digital signal processor (DSP) or Matlab®) the infinite sum need to be truncated to a finite number of terms, K, yielding

$$L ( X ) \approx {ⅇ}^{- 〈 {a}^{2} 〉 / 4 {σ}_{v}^{2}} [ {I}_{0} ( \frac{{r}_{1}}{{σ}_{v}^{2}} ) {I}_{0} ( \frac{{r}_{2}}{4 {σ}_{v}^{2}} ) + 2 {\sum }_{I = 1}^{K} {I}_{2 I} ( \frac{{r}_{1}}{{σ}_{v}^{2}} ) {I}_{I} ( \frac{{r}_{2}}{4 {σ}_{v}^{2}} ) cos ( I θ ) ] . \qquad ( 12 )$$

Here K is a user defined parameter that determines the accuracy of the likelihood estimate. A solution to the likelihood ratio can also be obtained by numerically solving the expression in Eq. (5). Since the integrand, Eq. (4), is known a solution to Eq. (5) can be obtained by standard numerical integration, e.g. quadrature integration with the Adaptive Newton Cotes 8 panel rule.

Hence, constructing a decision rule according to Eq. (3) where the likelihood ratio is computed according to Eq. (12) or by a numerical method described above, ensures optimal detection for all signals of the form (2) contaminated by additive Gaussian noise.

In order to illustrate the detection performance both the conventional Noncoherent Detector and the Generalized Noncoherent Detector (with K=10) were implemented in Matlab® and applied to a simulated vector valued transient signal contaminated by additive Gaussian noise. The simulated transient signal to be detected is of the form
Sₜ(φ)=aₜ sin((t−1)ω_{c}Tₛ+φ)
where the envelope is
aₜ=exp{−(t−t_{c})TₛIσₑₙᵥ}

Here t_{c} determines the location of the transient and σₑₙᵥ determines the time duration (band-width). In the simulations below t_{c}=0.5, the carrier frequency is ω_{c}=4π, the sampling interval is Tₛ=0.001, the sample points are t=1, . . . , N where N=1000 . An example of the signal sₜ(0) is presented in FIG. 1.

Performance of detectors is here presented in the form of conventional receiver operating characteristic (ROC) curves where the probability of detection P_{D} is displayed versus the probability of false alarm P_{F}. The minimum probability of error, P_{E}*, versus the transient signals time duration, σₑₙᵥ, is also used to evaluate detector performance.

The detector performance results are used to compare the Generalized Noncoherent Detector to the conventional Noncoherent Detector. This study clearly shows that the Generalized Noncoherent Detector yields a practically significant advantage over the conventional Noncoherent Detector when the narrow-band approximation does not hold. The difference between using the Generalized Noncoherent Detector versus using the classical approximation in terms of ROC curves for the case of σₑₙᵥ=0.1 is presented in FIG. 2. In FIG. 2 it can clearly be seen that the probability of detection curve for the Generalized Noncoherent Detector is strictly above the curve generated by the conventional Noncoherent Detector. Hence, the Generalized Noncoherent detector outperforms the conventional detector since it always has a higher probability of detection.

Another way to measure the detection performance is to study the minimum probability of error. It is beneficial for a detector to have as low probability of error as possible. In FIG. 3 it is shown that the Generalized Noncoherent Detector always has lower minimum probability of error compared to the Noncoherent Detector. In order to investigate the effect of the narrow-band approximation the band-width (i.e. time duration) of the transient signal was varied by using different values of σₑₙᵥ. This can cause the envelope aₙ_{₁} to change fast compared to the carrier sinusoid. The detector performance in terms of minimum probability of error was then estimated by means of Monte-Carlo simulation with 10000 signal realizations from H₀ and H₁, respectively, which is shown in FIG. 3.

1. A method for detecting a single or multi dimensional signal contaminated by additive Gaussian noise, where the signal is an amplitude modulated sinusoid with known, but arbitrary, envelope and carrier frequency, but unknown uniform phase angle, characterised in that the integral for the likelihood ratio
$$L ( X ) = \frac{1}{2 π} {\int }_{- π}^{π} {L}_{ϕ} ( X ) ⅆ ϕ$$
is calculated analytically or numerically without limiting assumptions, and compared with a threshold value for deciding the question of detection.

2. A method according to claim 1, characterised in that an analytical method is used giving the solution
$$L ( X ) \approx {ⅇ}^{- 〈 {a}^{2} 〉 / 4 {σ}_{v}^{2}} [ {I}_{0} ( \frac{{r}_{1}}{{σ}_{v}^{2}} ) {I}_{0} ( \frac{{r}_{2}}{4 {σ}_{v}^{2}} ) + 2 {\sum }_{I = 1}^{K} {I}_{2 I} ( \frac{{r}_{1}}{{σ}_{v}^{2}} ) {I}_{I} ( \frac{{r}_{2}}{4 {σ}_{v}^{2}} ) cos ( I θ ) ] ,$$
which solution is implemented numerically.

3. A detector for detecting a single or multi dimensional signal contaminated by additive Gaussian noise, where the signal is an amplitude modulated sinusoid with known, but arbitrary, envelope and carrier frequency, but unknown uniform phase angle, characterised in that the detector comprises a signal receiving device and a calculating device that calculates the integral for the likelihood ratio
$$L ( X ) = \frac{1}{2 π} {\int }_{- π}^{π} {L}_{ϕ} ( X ) ⅆ ϕ$$
analytically or numerically without limiting assumptions, and makes a comparison with a threshold value for deciding the question of detection.

4. A detector according to claim 4, characterised in that an analytical method is used giving the solution
$$L ( X ) \approx {ⅇ}^{- 〈 {a}^{2} 〉 / 4 {σ}_{v}^{2}} [ {I}_{0} ( \frac{{r}_{1}}{{σ}_{v}^{2}} ) {I}_{0} ( \frac{{r}_{2}}{4 {σ}_{v}^{2}} ) + 2 {\sum }_{I = 1}^{K} {I}_{2 I} ( \frac{{r}_{1}}{{σ}_{v}^{2}} ) {I}_{I} ( \frac{{r}_{2}}{4 {σ}_{v}^{2}} ) cos ( I θ ) ] ,$$
which solution is implemented numerically.
